(19) United States
(12) Patent Application Publication
(10) Pub. No.: US 2018/0118955 A1
(43) Pub. Date: May 3, 2018

(54) ANTIFOULING FILM

(71) Applicant: SP SVERIGES TEKNISKA FOR-SKNINGSINSTITUT AB, Borås (SE)

(72) Inventors: Mattias BERGLIN, Göteborg (SE); Emiliano PINORI, Borås (SE)

(21) Appl. No.: 15/572,109

(22) PCT Filed: May 3, 2016
(86) PCT No.: PCT/SE2016/050393

§ 371 Date: Nov. 6, 2017

(30) Foreign Application Priority Data
May 8, 2015 (SE) 1550590-2

(51) Int. Cl. C09D 5/16

(52) U.S. Cl. CPC C09D 5/1625; B63B 59/04; C09D 5/1693

(57) ABSTRACT

There is provided a polymeric film adapted to be applied to a surface intended to be submerged, such as a boat hull surface, wherein abamectin is embedded in the film and the concentration of abamectin in the film is 0.01-1% by weight.

### TECHNICAL FIELD

The present disclosure relates to protection of submerged surfaces, such as boat hull surfaces, against fouling.

### BACKGROUND

Anti-fouling paint or bottom paint is often applied to the hull of a ship or boat to slow or prevent the growth of subaquatic organisms that attach to the hull and can affect aesthetics as well as the performance and durability of the ship or boat.

Antifouling paints are often formulated with copper, organotin compounds (i.e. tin-based compounds with hydrocarbon substituents) or other biocides that reduce growth of barnacles, algae and/or marine organisms.

Many of the traditional biocides are however associated with environmental concerns and legislations are developed to prevent their use.

### SUMMARY

The present inventors have addressed the need for anti-fouling that is not based on copper, tin or any other metal-containing polluting biocide. Further, the inventors have realized that instead of adding the antifouling biocide in bottom paint, it can be incorporated in a film that is easily applied to and removed from a surface intended to be submerged, such as a boat hull. Thereby, the burdensome work of applying and removing paint from a boat hull can be reduced, if not avoided. The inventors have also identified a particularly effective biocide (abamectin) that can be trapped in the film and exhibits anti-fouling activity in such a trapped state. The antifouling concept of the present disclosure is thus not dependent on release of a biocide. Rather, the release is reduced to such low levels that significant environmental benefits are obtained. Another benefit of the biocide of the present disclosure is that substantially no toxic compounds are formed when it is combusted, which means that it is relatively easy to handle from a waste management perspective.

There is thus provided a polymeric film adapted to be applied to a surface intended to be submerged, such as a boat hull surface. Abamectin is embedded in the film and the concentration of abamectin in the film is 0.01-1% by weight.

### BRIEF DESCRIPTION OF THE FIGURE

FIG. 1 illustrates an embodiment of a multi-layered film according to the present disclosure.

### DETAILED DESCRIPTION

There is thus provided a polymeric film adapted to be applied to a surface intended to be submerged. The film of the present disclosure is thus formed before it is applied to the surface, which means that it is different from an anti-fouling paint.

Abamectin is embedded in the film. For example, the abamectin may be dispersed and/or dissolved in the film. Thereby, the abamectin may be evenly distributed in the film. Accordingly, the abamectin is normally not covalently bound to the polymer(s) of the film. Instead, abamectin is normally “trapped” in the film primarily by steric hindrance and van der Waal forces.

When the film comprises a plasticizer (see the discussion below), abamectin may be dissolved in the plasticizer and then added to a polymer composition before the film is formed. Thereby, even distribution of the abamectin in the film may be achieved.

The concentration of abamectin in the film is 0.01-1% by weight. If the concentration is too low, the anti-fouling effect is insufficient. If the concentration is too high, the release rate may be too high, which can be associated with environmental concerns. Further, high amounts of abamectin may render the film unnecessarily costly. Preferably, concentration of abamectin in the film is 0.03-0.8% by weight, such as 0.05-0.5% by weight, such as 0.05-0.3% by weight.

If the film is too hard, the anti-fouling effect may be reduced. For example, barnacles may be unable to penetrate the film and contact the embedded abamectin when the film is too hard. Therefore, the Buchholz hardness of the film is preferably less than 85, such as 80 or less, such as 70 or less. If the film is too soft, it may however be too sensitive and difficult to handle. Therefore, the Buchholz hardness of the film is preferably at least 10, such as at least 15, such as at least 20. In one embodiment, the Buchholz hardness is 30-65, such as 30-50. The Buchholz hardness can be measured according to ISO 2815-2003.

To avoid a film that is too hard, the glass transition temperature (Tg) of the film may be adjusted to be lower than the water temperature. Accordingly, the Tg of the film is preferably below 25° C., such as below 20° C., such as below 15° C., such as below 10° C., such as below 5° C., such as below 0° C. At the same time, the Tg of the film is preferably kept above −120° C. The Tg is preferably measured with differential scanning calorimetry (DSC) according to standard ASTM D7426.

As well known to the skilled person, a plasticizer may be used to reduce the hardness and the brittleness of a polymeric film. Accordingly, the film of the present disclosure may comprise one or more plasticizers. Some examples of plasticizers are sebacates, adipates, terephthalates, dibenzoates, gluterates, phthalates, azelates and epoxified vegetable oils. When added, the concentration of plasticizer in the film is normally 0.1-10% by weight, such as 0.5-10% by weight. When the film comprises polyvinylchloride (PVC), the concentration of plasticizer may however be as high as 50 or 55%.

To facilitate handling and application of the film, it may be preferred if its stretchability (stretch at break) is at least 60%, such as at least 80%, such as at least 100%. Further, the stretchability is often less than 300%, such as 200% or lower. A preferred range is thus 100-200%. A particularly suitable stretchability is about 140%. The stretchability is determined by ISO 29864:2007. For the same reasons, the thickness of the film may be 20-200 μm, such as 30-100 μm as determined by ASTM D1005.

In one embodiment an adhesive is provided on one side of the film such that the film can adhere to the surface intended to be submerged. Such an adhesive may for example be covered by a release layer, wherein the release layer is designed to be removed and thereby expose the adhesive before application. The release layer may for example be a release liner, which comprises a base of paper or plastic that is covered with a release agent. An example of a release agent is silicone.

The adhesive may for example be pressure-activated. Accordingly, the film may be applied to the surface in question by hand and positioned by light finger pressure. A firm pressure may then be used to fixedly attach the film to the surface. Another example is a temperature-activated adhesive. When such an adhesive is used, heat is applied during application of the film.

As discussed above, the abamectin is “trapped” in the film of the present disclosure, which means that the release of abamectin is minimized. This has at least two benefits. Firstly, abamectin from the film is not polluting the environment to any significant degree. Secondly, the anti-fouling effect lasts for a long period of time.

Abamectin's poor solubility in water is one cause of the low release rate. By minimizing the film's water absorption, the release rate is further reduced. Accordingly, the film's water uptake according to standard ASTM D570:2010 is preferably less than 10%, such as less than 5%. Another way of reducing the release rate is to select polymer(s) for the film that has/have a surface free energy according to the standard SS-EN 828:2013 of 15-50 mJ/m², such as 18-40 mJ/m², such as 21-30 mJ/m². Thereby, the contact between the water and the abamectin in the film is reduced.

The inventors have further realized that the addition of nanoparticles, such as nano clay, such as flaky or hyper-flaky nano clay, to the film can reduce the release rate. In one embodiment, the film of the present disclosure may thus comprise dispersed nanoparticles, preferably in a concentration of 0.5-10% by weight, such as 1-5% by weight.

Preferably, the rate of release of abamectin from the film is less than 30 ng/cm²/day according to ISO 15181-1:2007. More preferably, it is less than 20 ng/cm²/day, such as less than 10 ng/cm²/day, such as less than 8 ng/cm²/day.

Crystalline zones in the film cannot dissolve abamectin. Abamectin is thus generally less evenly distributed in a polymeric film having a high proportion of crystalline zones. Therefore, it is beneficial to keep the crystallinity in the film low. Preferably, the degree of crystallinity of the polymer(s) of the film is less than 40%, such as less than 30%, such as less than 20%, such as less than 10%. The crystallinity is preferably measured according to standard ASTM F2625 by using the heat of fusion for a 100% crystalline polymer.

The film of the present disclosure may comprise one polymer or a blend of different polymers. Each polymer may be a homopolymer or a copolymer. Further, each polymer may be branched or unbranched. The polymer or polymer blend of the film can be cross-linked. The polymer(s) of the film may for example be selected from acrylic polymers, polyurethans, polyolefins, vinyl polymers and silicones.

The film of the present disclosure may also comprise an inorganic filler, such as talc or pigment. The effect of an inorganic filler may be improved barrier properties, wear resistance and/or printability. A pigment may also provide a coloured film, which may be desired for aesthetic purposes.

The film may further comprise one or more of the following additives:

an antioxidant or stabilizer, such as a sterically hindered phenol;

carbon black; and

a film blowing agent, such as sodium bicarbonate.

The present disclosure further provides a multilayer film comprising a first and a second layer, wherein the first layer is the film discussed above. In contrast to the first layer, no abamectin has been added to the second layer. One effect of the second layer is thus that the release of abamectin is reduced further.

The second layer is preferably a polymeric layer. Suitable polymeric components of the second layer are discussed in connection with the first layer (i.e. the film). The polymer(s) of the second layer preferably has/have a surface free energy according to the standard SS-EN 828:2013 of 10-25 mJ/m², such as 12-25 mJ/m², such as 13-20 mJ/m². Accordingly, the surface free energy of the polymer(s) of the second layer is preferably lower than the surface free energy of the polymer(s) of the first layer. The second layer forms the outermost layer after application and provides a “super slippery” outer surface. Many subaquatic organisms cannot attach to such an outer surface. In particular, the organisms become detached when there is a relative movement of the surface, e.g. when a boat is driving such that there is a relative movement between its hull and the water.

The second layer is preferably thinner (ASTM D1005) than the first layer. For example, the thickness according to ASTM D1005 of the second layer may be 5-25 μm, such as 7-20 μm. The thinner second layer may comprise (a) higher concentration(s) of one or more additives than the first layer. As additives may be expansive, such a design may reduce the cost of the product. For example, the second layer may comprise 1-15% by weight of nano clay or another inorganic filler, while the first layer comprises less than 1% by weight of nano clay or the other inorganic filler, such as no nano clay or inorganic filler. The nano clay or inorganic filler of the second layer further reduces the release of abamectin.

If the second layer is too hard, the anti-fouling effect may be reduced. For example, barnacles may be unable to penetrate the second layer and contact the abamectin embedded in the first layer if the second layer is too hard. Therefore, the Buchholz hardness (ISO 2815-2003) of the multi-layered film provided with the second layer is preferably less than 85, such as 80 or less, such as 70 or less. In one embodiment, the Buchholz hardness (ISO 2815-2003) of the multi-layered film provided with the second layer is 15-65, such as 30-65, such as 30-50.

To avoid that the second layer is too hard, the glass transition temperature (Tg) may be adjusted to be lower than the water temperature. Accordingly, the Tg of the second layer is preferably below 25° C., such as below 20° C., such as below 15° C., such as below 10° C., such as below 5° C., such as below 0° C. At the same time, the Tg of the second layer is preferably kept above −120° C.

The stretchability, water uptake and abamectin release rate of the multi-layered film comprising the second layer may have the same values as those discussed above.

The film or the multi-layered film discussed may be wounded up to form a roll to facilitate transport and handling.

In the present disclosure, “abamectin” refers to avermectin B₁ₐ (CAS 65195-55-3) or a mixture of avermectin B₁ₐ and avermectin B_{1b} (CAS 65195-56-4). Such a mixture preferably contains more than 50% by weight of avermectin B₁ₐ and less than 20% by weight of avermectin B_{1b}. In one embodiment, the mixture contains 80% or more by weight of avermectin B₁ₐ and 20% or less by weight of avermectin B_{1b}.

The only difference between the chemical formulas of avermectin B₁ₐ and avermectin B_{1b} is one substituent (R). In avermectin B₁ₐ, R is ethyl and in avermectin B_{1b}, R is methyl

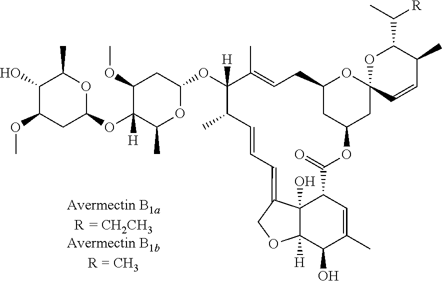

### EXEMPLARY EMBODIMENTS

### Example 1

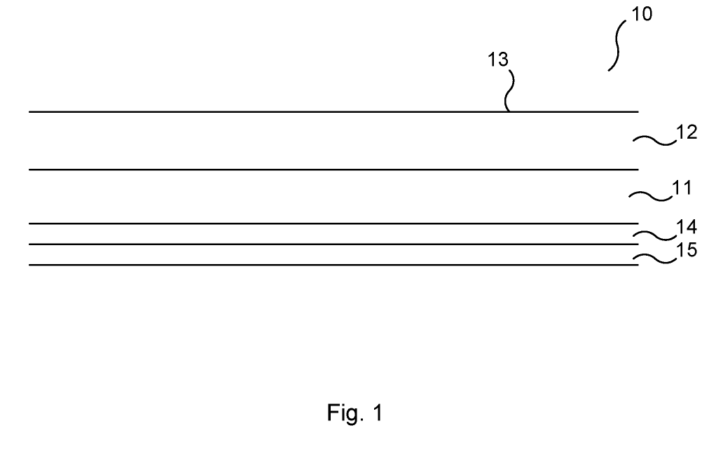

FIG. 1 illustrates an embodiment of a multi-layered film 10 according to the present disclosure. The multi-layered film comprises a polymeric film 11 in which abamectin is embedded and evenly distributed. The concentration of abamectin in the polymeric film is 0.1% by weight. However, another concentration in the range 0.01-1% can also be used. The embedded abamectin reduces barnacle growth. The top side of the polymeric film 11 may be covered with a top polymeric layer 12 that contains no abamectin. The top surface 13 of the top polymeric layer 12 is slippery to prevent subaquatic organisms other than barnacles from firmly attaching to it. It is understood that the top surface 13 of the top polymeric layer 12 is the outermost surface when the multi-layered film 10 has been applied to a submerged surface. The bottom side of the polymeric film 11 may be covered by an adhesive layer 14. The purpose of the adhesive layer 14 is to adhere the multi-layered film 10 to a surface intended to be submerged in water, such as a boat hull surface. The adhesive layer 14 may be covered by a release layer 15, such as a release liner comprising a paper base coated with a release agent (e.g. silicone). Such a release layer 15 is designed to be removed before application such that the adhesive layer 14 is exposed.

### Example 2

PVC film

Material and Methods

Film Formation

A plastisol made of emulsion polymerized polyvinyl chloride (PVC) paste, plasticizer (diisopropyl phtalate, DINP) and a Ba—Zn stabilizer (Lankromark LZB567) and pigment (carbon black) was prepared by mixing according to the concentrations shown in Table 1. Abamectin was dissolved in DINP prior to mixing at ratios giving the final concentration (wt %) shown in Table 1. Thin films of the plastisol were applied with a film applicator set at 500 μm. The plastisol films were baked at 180° C. for 4 minutes to drive the plasticizer into the PVC and thus forming the final PVC film. Control PVC film not containing abamectin was also prepared.

TABLE 1
Composition of PVC film.

| Component | Parts per hundred (Phr) | Prepared (g) |
|---|---|---|
| Polyvinyl chloride, PVC | 100 | 300 |
| Diisopropyl phtalate, DINP | 40 | 120 |
| Ba—Zn stabilizer | 2 | 6 |
| Carbon black | 0.1 | 0.3 |
| Abamectin | 0.1 | 0.43 |

Characterizations

The morphology and of both surface and cross-sections of the pristine PVC films was analyzed using scanning electron microscopy (SEM). The dry PVC film thickness was measured from cross-sections. The presence of phase separated domains or other chemical surface features were evaluated by time-of-flight secondary ion mass spectroscopy (ToF-SIMS). The Buchholz film hardness was evaluated according to ISO standard ISO 2815-2003. The release rate of abamectin was measured according to ISO 15181-1:2007. The efficacy was estimated in field studies at the west coast of Sweden (Tjärnö) during the summer season of 2015.

Results

The surface interface and cross-sectional analysis revealed no cracks or other imperfections as analysed using SEM. On the surface the PVC crystalline lamellas was regularly observed. Air bubbles were observed when analyzing the cross-sections of the film but the presence is low and not significantly affecting any property of the PVC film. The film thickness was measured to be around 400 μm from the cross-sectional analysis. Abamectin and the other PVC film components were well distributed within the PVC film as no evidence of phase separated domains was observed by Tof-SIMS. The Buchholz hardness was measured to be 32.2±1.9 (95% confidence interval). The steady state release rate (measured after 35 days of immersion in artificial seawater) was found to be 43±22 ng/cm²*day (95% confidence interval). The film with abamectin showed very good efficacy and no presence of barnacles was observed after one full summer season. High degree of barnacle settling was observed on the control PVC.

1. A polymeric film adapted to be applied to a surface intended to be submerged, such as a boat hull surface, wherein:
abamectin is embedded in the film; and
the concentration of abamectin in the film is 0.01-1% by weight, such as 0.03-0.8% by weight, such as 0.05-0.5% by weight, such as 0.05-0.3% by weight.

2. The film of claim 1 , wherein an adhesive, such as a pressure-activated or temperature-activated adhesive, is provided on one side of the film such that the film can adhere to the surface intended to be submerged.

3. The film of claim 1, wherein the glass transition temperature (Tg) of the film is below 25° C., such as below 20° C., such as below 15° C., such as below 10° C., such as below 10° C., such as below 5° C., such as below 0° C. and wherein Tg is measured with differential scanning calorimetry (DSC) according to ASTM D7426.

4. The film of claim 1, wherein the surface free energy according to SS-EN 828:2013 of the polymer(s) of the film is15-50 mJ/m², such as 18-40 mJ/m², such as 21-30 mJ/m².

5. The film of claim 1, wherein the degree of crystallinity of the polymer(s) of the film is less than 40%, such as less than 30%, such as less than 20%, such as less than 10% and wherein the crystallinity is measured according to ASTM F2625 by using the heat of fusion for a 100% crystalline polymer.

6. The film of claim 1, which has a thickness according to ASTM D1005 of 20-200 μm, such as 30-100 μm.

7. The film of claim 1, wherein the polymer(s) of the film is/are selected from acrylic polymers, polyurethans, polyolefins, vinyl polymers and silicones.

8. The film of claim 1, further comprising at least one plasticizer, wherein the concentration of plasticizer in the film is 0.1-55% by weight, such as 0.1-10% by weight, such as 0.5-10% by weight.

9. The film of claim 1, further comprising dispersed nanoparticles, such as nano clay, in a concentration of 0.5-10% by weight, such as 1-5% by weight.

10. The film of claim 1, further comprising an inorganic filler, such as talc.

11. A multi-layered film comprising a first and a second layer, wherein the first layer is the film according to claim 1, and wherein no abamectin has been added to the second layer.

12. The multi-layered film of claim 11, wherein the second layer is a polymeric layer and the polymer(s) of the second layer has/have a surface free energy according to SS-EN 828:2013 of 10-25 mJ/m², such as 12-25 mJ/m², such as 13-20 mJ/m².

13. The multi-layered film of claim 11, wherein the thickness according to ASTM D1005 of the second layer is 5-25 μm, such as 7-20 μm.

14. The film or multi-layered film of claim 1, wherein the Buchholz hardness according to ISO 2815-2003 of the film or multi-layered film is less than 85, such as 10-80, such as 15-70, such as 30-65, such as 30-50.

15. The film or multi-layered film of claim 1, wherein the stretchability of the film or multi-layered film according to ISO 29864:2007 is at least 60%, such as at least 80%, such as 100-200%.

16. The film of any one of the preceding claims, wherein the water uptake according to ASTM D570:2010 of the film is less than 10%, such as less than 5%.

17. The film or multi-layered film of claim 1, wherein release rate according to ISO 15181-1:2007 of abamectin is less than 30 ng/cm²/day, such as less than 20 ng/cm²/day, such as less than 10 ng/cm²/day, such as less than 8 ng/cm²/day.

18. A roll of a film or a multi-layered film according to claim 1.

19. Use of a film or a multilayer film according to claim 1 for protecting a submerged surface, such as a boat hull surface, against fouling, such as barnacle fouling.
